(19) United States
(12) Patent Application Publication
(10) Pub. No.: US 2005/0048436 A1
(43) Pub. Date: Mar. 3, 2005

(54) Handpiece apparatus and method for dispensing media

(76) Inventors: Udi Fishman, Los Gatos, CA (US); Tal Morr, Hollywood, FL (US); Joellen S. Fishman, Los Gatos, CA (US); Valeriy Litvak, Los Gatos, CA (US)

Correspondence Address: Richard C. Litman;LITMAN LAW OFFICES, LTD., P.O. Box 15035, Arlington, VA, 22215, US

(21) Appl. No.: 10/928,125

(22) Filed: Aug. 30, 2004

Related U.S. Application Data
(60) Provisional application No. 60/498,774, filed on Aug. 29, 2003.

(51) Int. Cl. A61C 17/00; A61C 3/00

(52) U.S. Cl. 433/80; 433/29

(57) ABSTRACT

A handpiece apparatus and/or method for dispensing media, and that can include one or more lights for illumination and/or for curing of composite materials. The handpiece apparatus includes a heat source with a flow diverter to enhance heat transfer to the media, and a temperature controller that synchronizes the heat source with the fluid and/or gaseous flow. The handpiece apparatus has an accumulator chamber that temporarily removes transient flow that has not reached a predetermined temperature and then gradually recirculates it back into the media flow after the media reaches a predetermined temperature so that the media is dispensed at an elevated and uniform temperature. The handpiece apparatus can have one or more light sources for illumination and/or for curing composite materials. The handpiece apparatus dispensing nozzle acts as a light pipe to direct and focus illumination from an internal light source onto the work area.

### CROSS REFERENCE TO RELATED APPLICATION

This application claims priority to U.S. Provisional Application Ser. No. 60/498,774, filed Aug. 29, 2003, which is incorporated herein by reference.

### BACKGROUND OF THE INVENTION

1. Field of the Invention

The present invention relates generally to a dental handpiece apparatus and, more particularly, to a handpiece apparatus and/or method for dispensing media including heated water, air, or other fluid or gaseous media, and that can provide illumination and curing of composite materials.

2. Description of the Related Art

Dental syringe handpieces are commonly used in dental offices for irrigating, rinsing, and drying a localized work area within the oral cavity during the performance of various dental procedures. These dental handpieces dispense pressurized air and water, and may also be used to supply other fluids and/or gasses as required by the dental practitioner. These fluids and/or gaseous media are commonly supplied at room temperature from a reservoir tank located near the chair. Alternately, filtered municipal water may be used. The media is presented at a temperature substantially lower than body temperature, and this can cause acute discomfort to the patient when applied to sensitive areas inside the mouth. Some attempts have been made to heat the water to a more comfortable temperature, but the shortcomings inherent to these systems have prevented them from coming into general use.

One of the problems that these systems have failed to address is that the initial flow of media dispensed at each use is cooler than the desired temperature for patient comfort. Since the handpiece is used intermittently, the media cools inside the handpiece's own internal tubing during the wait between uses, and therefore the initial squirt is dispensed at a substantially lower temperature, causing discomfort to the patient. In addition, since the duration of dispensing is typically quite short, the media dispensed may not come up to the required temperature during the length of time in which it is dispensed.

The extent of cooling is unpredictable, and the amount of media that must be purged from the system before it is dispensed at the desired temperature is also variable. Attempts have been made to solve this problem, however they have succeeded only in shortening the duration in which the cooler media is dispensed from the nozzle. They have not successfully eliminated the flow of cooler media to the work area. This shortcoming has prevented such devices from coming into general use, because if the media cannot be dispensed at the required temperature instantly and consistently, it is of no practical use to heat it at all.

In addition, some dental handpieces have incorporated a light source, however, the light source has been typically placed at the base of the nozzle, pointing generally at the work area. The nozzle typically contains an angled section, and therefore the illumination is generalized and not focused on the immediate work area, and the nozzle may throw shadows on the work area. In order to provide sufficient light over a generalized area, a more powerful light source must be used.

In addition, lights of certain wavelengths or intensities are used to cure dental composite materials. Typically the dentist must prepare an area by rinsing and drying, and then switch to a different handpiece to cure a composite applied to the work area. The incorporation of a curing light into the air water syringe would reduce the number of tools required and eliminate an interruption in the work process.

Thus, a handpiece apparatus and/or method for dispensing heated water, air, or other fluid or gaseous media solving the aforementioned problems, and that can provide illumination and curing of composite materials is desired.

### SUMMARY OF THE INVENTION

The present invention is a handpiece apparatus and/or method for dispensing media including heated water, air, or other fluid or gaseous media, and that can include one or more lights for illumination and/or for curing of composite materials. The handpiece apparatus includes a heat source with a flow diverter to enhance heat transfer to the media, and a temperature controller that synchronizes the heat source with the fluid and/or gaseous flow. The handpiece apparatus has an accumulator chamber that temporarily removes transient flow that has not reached a predetermined temperature and then gradually recirculates it back into the media flow after the media reaches a predetermined temperature so that the media is dispensed at an elevated and uniform temperature. The handpiece apparatus can have one or more light sources for illumination and/or for curing composite materials. The handpiece apparatus dispensing nozzle acts as a light pipe to direct and focus illumination from an internal light source onto the work area.

The handpiece apparatus dispenses water, air, or other fluid or gaseous media, wherein such media is heated within the handpiece apparatus as close to the nozzle as possible to minimize the volume of media standing in the tubes past the heating device between uses. In addition, the media remaining in the passageways after each use is recirculated to avoid dispensing any media at a temperature that is not within the desired temperature range. In order to recirculate the cooler media, the handpiece apparatus utilizes an accumulator chamber upstream from the heating device, adjacent to the dispensing nozzle. The initial flow of media is diverted into the accumulator chamber so that the first squirt of media that exits the nozzle is dispensed at the desired temperature. As the flow continues, the contents of the accumulator chamber are gradually released back into the stream of heated water. This occurs after the media flow reaches a sufficiently high temperature so that the effect of the slow discharge from the accumulator does not noticeably reduce the temperature of the stream, and therefore the media stays within the desired temperature range. After the accumulator chamber is evacuated, it remains empty to permit the process to be repeated on subsequent use of the handpiece apparatus.

Accordingly, it is a principal aspect of the invention to provide a handpiece apparatus and/or method for dispensing media, the handpiece apparatus including a housing, heating means for heating media to a temperature within a predetermined temperature range, and lighting means for effecting at least one of the group consisting of illuminating a work area, and curing at least one composite material, the lighting means having at least one light source and being positioned within the housing of the handpiece apparatus, wherein the handpiece apparatus is configured to dispense media within the predetermined temperature range, and to effect at least one of the group consisting of illuminating the work area, and curing the at least one composite material.

This handpiece apparatus may have temperature controlling means for regulating the heating means for heating media to a temperature within the predetermined temperature range. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

This handpiece apparatus may include temperature sensing means for sensing temperature of media, and motion sensing means for sensing motion of the handpiece apparatus and activating the heating means upon sensing motion of the handpiece apparatus. The handpiece apparatus may have removable nozzle means for dispensing media to a work area, and swiveling means for orienting the removable nozzle means at a variety of angles in a work area.

It is another aspect of the invention to provide a handpiece apparatus and/or method for dispensing media that includes heating means for heating media to a temperature within a predetermined temperature range, chambering means for accumulating media, and diverting means for diverting media to the chambering means when pressure within the chambering means is below a predetermined opening pressure threshold, wherein the handpiece apparatus is configured to dispense media within the predetermined temperature range.

This handpiece apparatus may be configured with flow restricting means for discharging media from the chambering means into media heated by the heating means, valving means for activating flow of media, and switching means for activating the heating means. The diverting means may include vacuum generating means for causing media in the chambering means to empty back into media heated by the heating means, and pressure relief valving means for assuming an open position when the predetermined opening pressure is exceeded in the chambering means, and remaining in the open position until the pressure in the chambering means falls below a predetermined closing pressure.

This handpiece apparatus may have flow restricting means for restricting flow of media from the chambering means when the media has a temperature value below a predetermined temperature value. This handpiece apparatus may have lighting means for effecting at least one of the group consisting of illuminating a work area, and curing at least one composite material. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

It is a further aspect of the invention to provide a handpiece apparatus may have and/or method for dispensing media that includes heating means for heating media to a temperature within a predetermined temperature range, and motion sensing means for sensing motion of the handpiece apparatus and activating the heating means upon sensing motion of the handpiece apparatus, wherein the handpiece apparatus is configured to dispense media within the predetermined temperature range. The handpiece apparatus may have valving means for activating flow of media, and switching means for activating the heating means. The handpiece apparatus may have lighting means for effecting at least one of the group consisting of illuminating a work area, and curing at least one composite material. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

Still another aspect of the invention is to provide a handpiece apparatus and/or method for dispensing media that includes a housing, light piping means for passing light therethrough, lighting means for effecting at least one of the group consisting of emitting light through the light piping means and onto a work area, and curing at least one composite material, the lighting means having at least one light source and being positioned within the housing, and dispensing means for dispensing media from the handpiece apparatus, wherein the handpiece apparatus is configured to dispense media in the work area being illuminated by the light means. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

Yet another aspect of the invention is to provide an apparatus for controlling flow of media that includes at least one inlet port means for receiving media, at least one outlet port means for dispensing media, and a snap action check valving means for assuming an open position when a predetermined opening pressure is exceeded at the at least one inlet port means, and remaining in the open position until pressure at the at least one inlet port means falls below a predetermined closing pressure, wherein the predetermined opening pressure is substantially greater than the predetermined closing pressure. The snap action check valving means includes a flexible convex dome, wherein in the closed position the convex surface of the dome is in contact with the at least one inlet port means and forms a seal between the dome and the at least one inlet port means.

It is an aspect of the invention to provide improved elements and arrangements thereof in a handpiece apparatus and/or method for dispensing media including water, air, or other fluid or gaseous media for the purposes described which is inexpensive, dependable, and fully effective in accomplishing its intended purposes.

These and other aspects of the present invention will become readily apparent upon further review of the following specification and drawings.

### BRIEF DESCRIPTION OF THE DRAWINGS

FIG. 1 is a top front perspective view of a handpiece apparatus according to the present invention.

FIG. 2 is a bottom front perspective view of a handpiece apparatus according to the present invention.

FIG. 3 is a top view of the handpiece apparatus shown in FIGS. 1 and 2.

FIG. 4 is a side view of the handpiece apparatus shown in FIGS. 1 and 2.

FIG. 5 is a side view of the interior of the handpiece apparatus shown in FIGS. 1 and 2.

FIG. 6 is a top view of the interior of the handpiece apparatus shown in FIGS. 1 and 2.

FIG. 7 is a cross-sectional side view of the handpiece apparatus shown in FIG. 3.

FIG. 8 is a cross-sectional side view of the handpiece apparatus shown in FIG. 3.

FIG. 9 is a cut away view of the handpiece apparatus shown in FIG. 7.

FIG. 10 is a cut away view of the handpiece apparatus shown in FIG. 7.

FIG. 11 is a cut away view of the handpiece apparatus shown in FIG. 4.

FIG. 12 is a cut away view of the handpiece apparatus shown in FIG. 4.

### DETAILED DESCRIPTION OF THE PREFERRED EMBODIMENTS

The present invention is a handpiece apparatus and/or method for dispensing media including heated water, air, or other fluid or gaseous media, and that can include one or more lights for illumination and/or for curing of composite materials. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

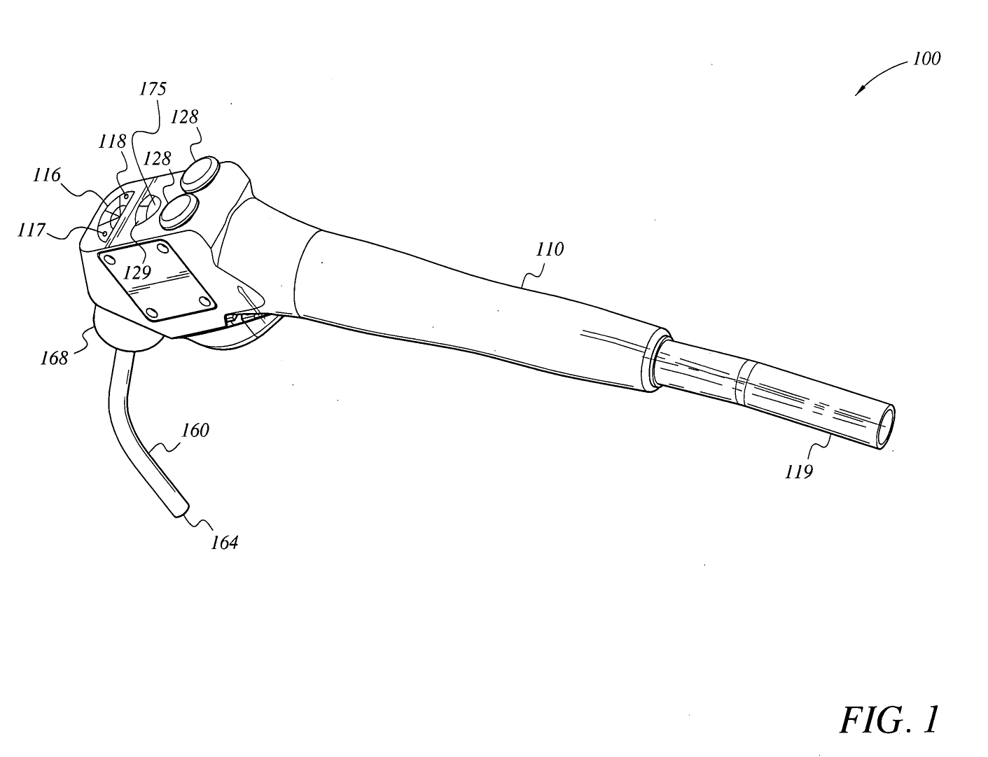

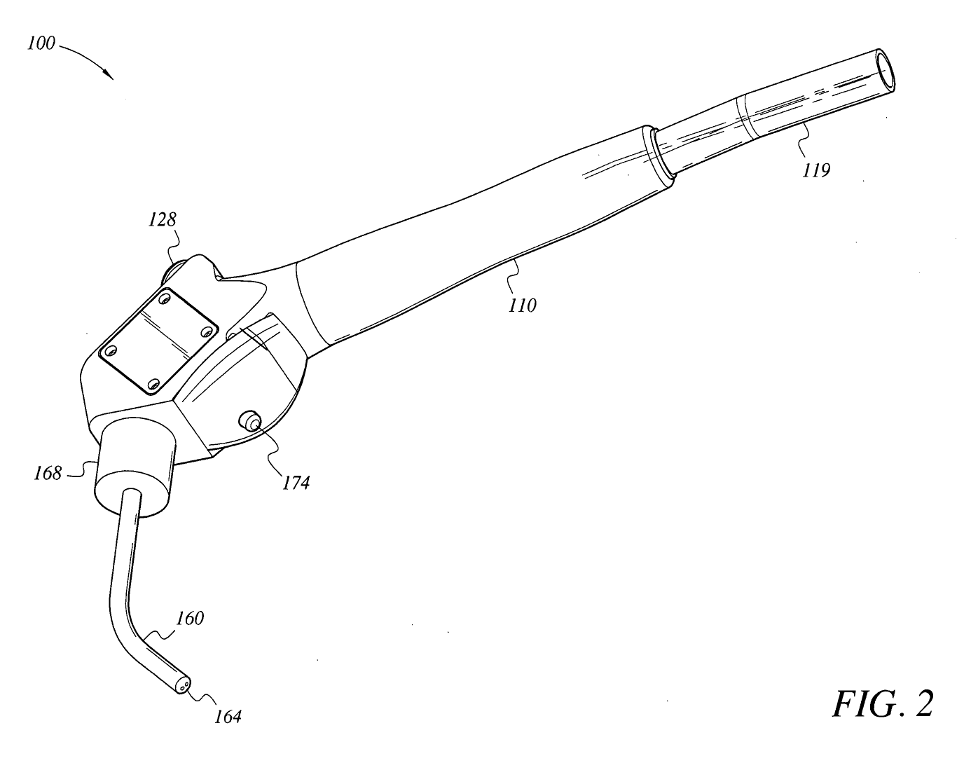

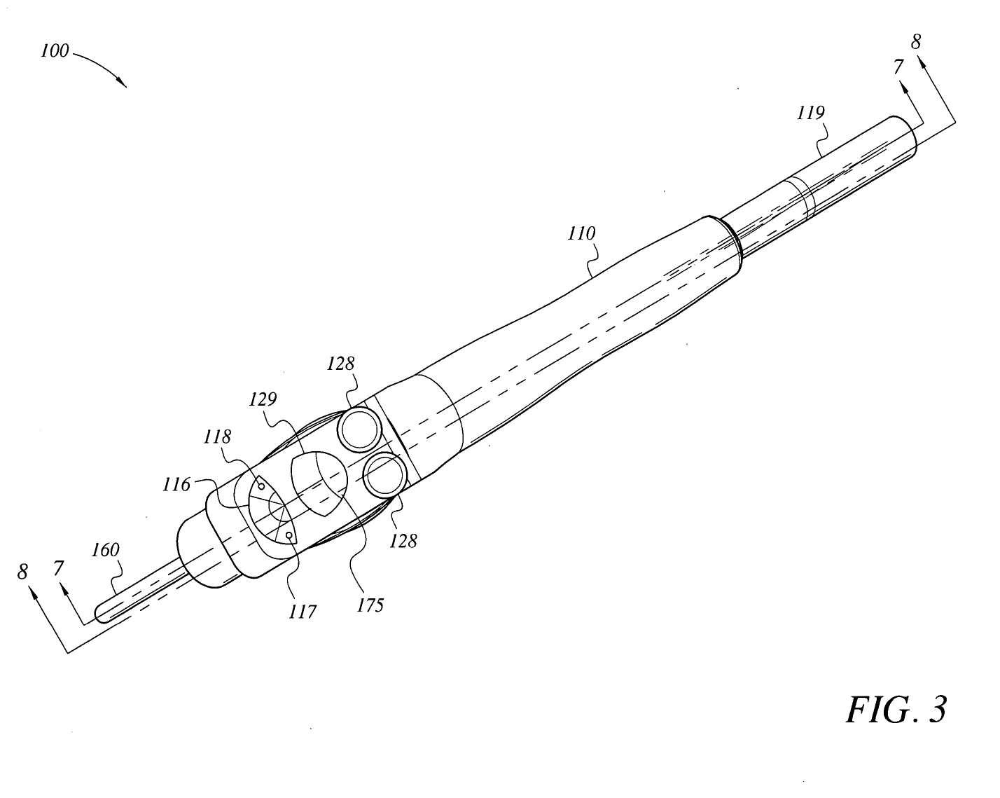

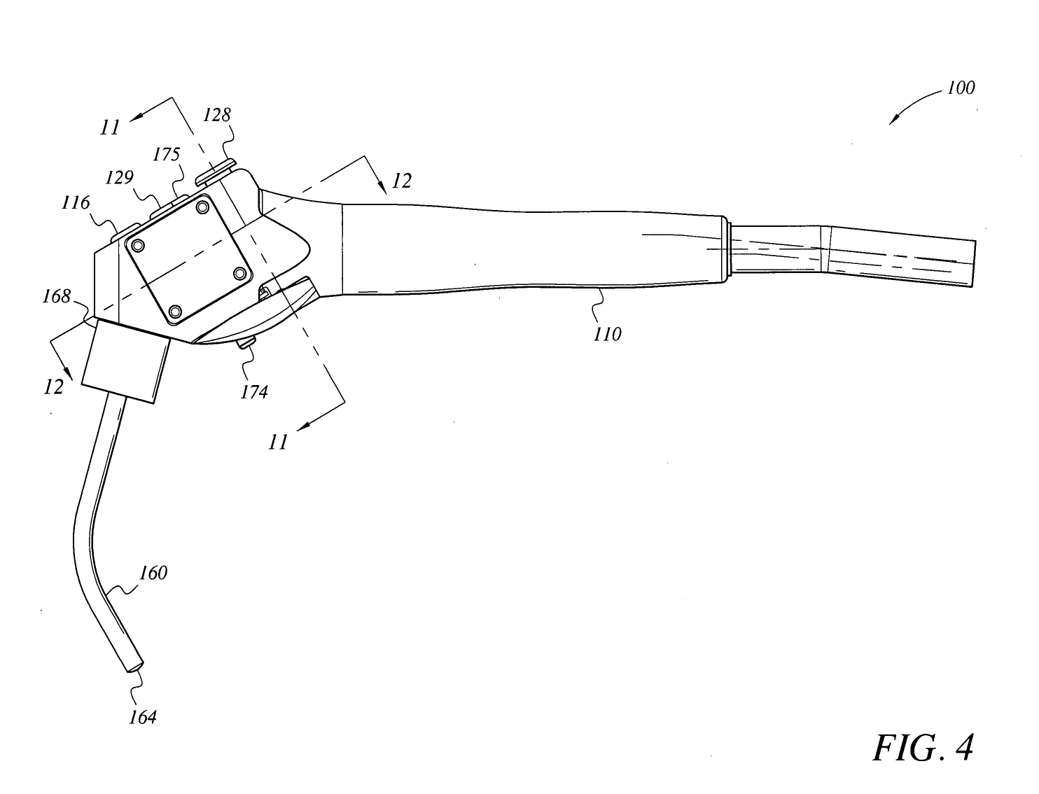

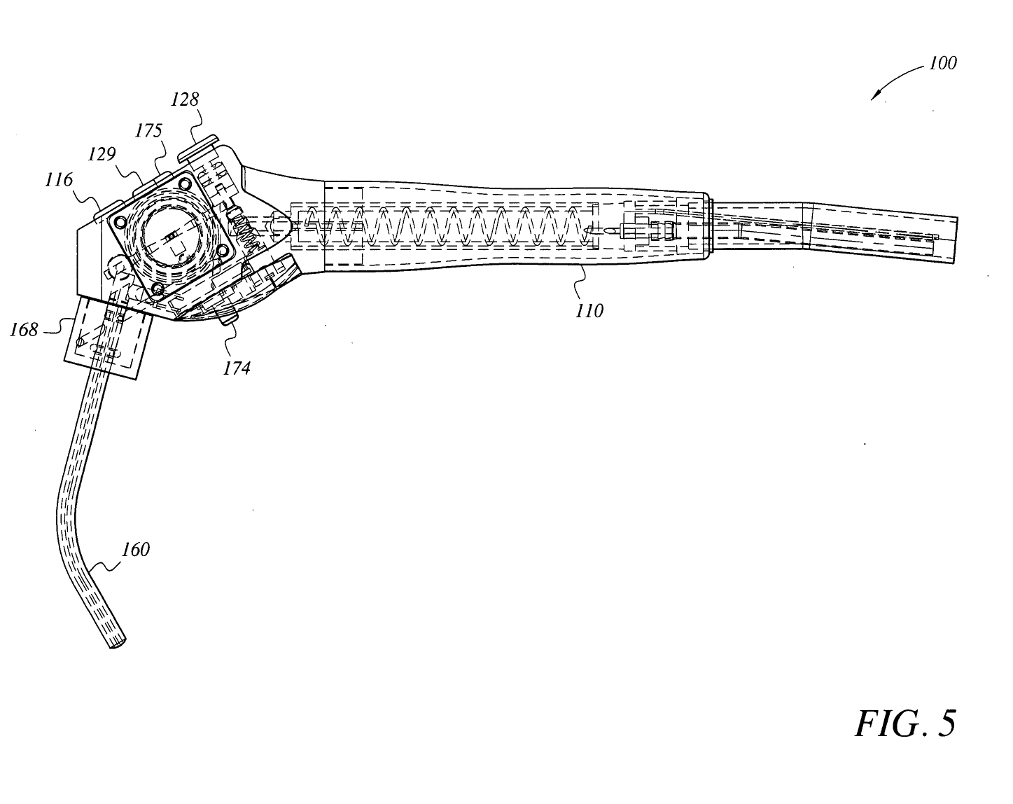

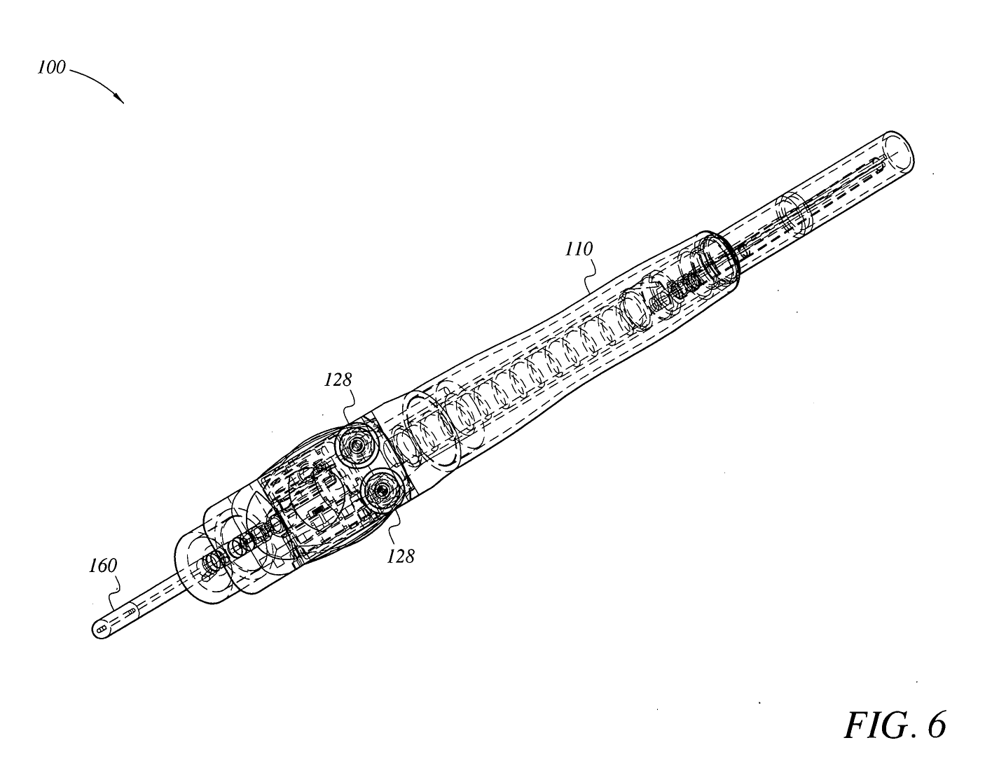

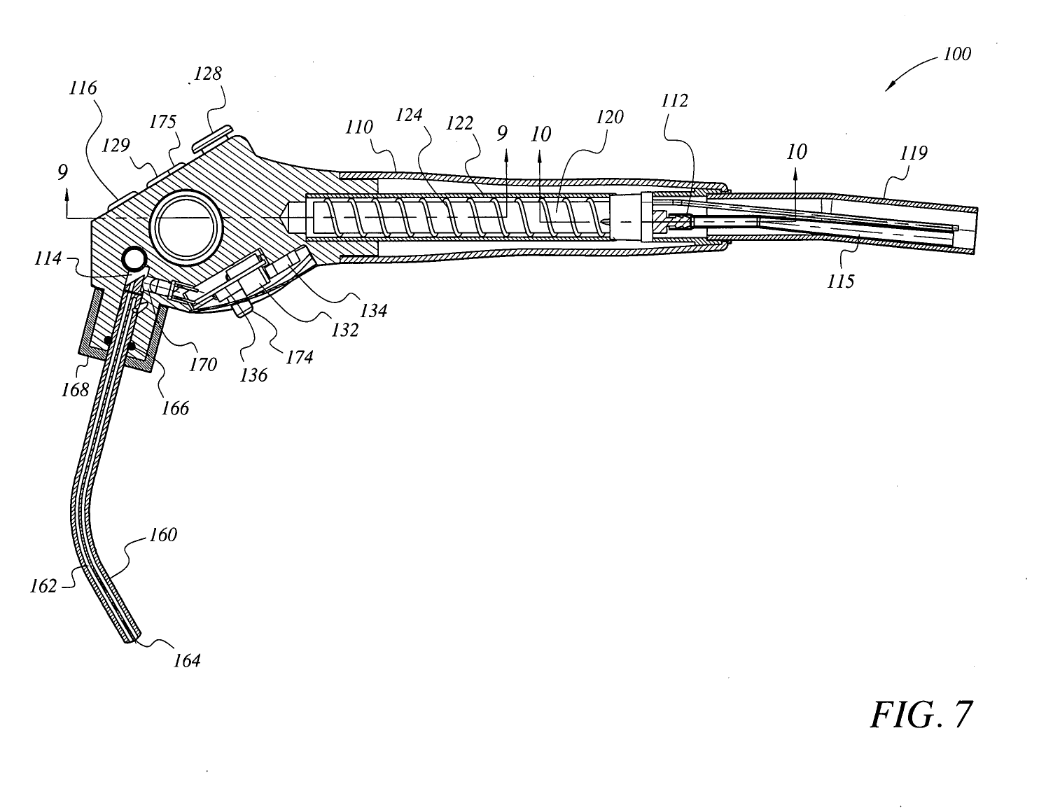

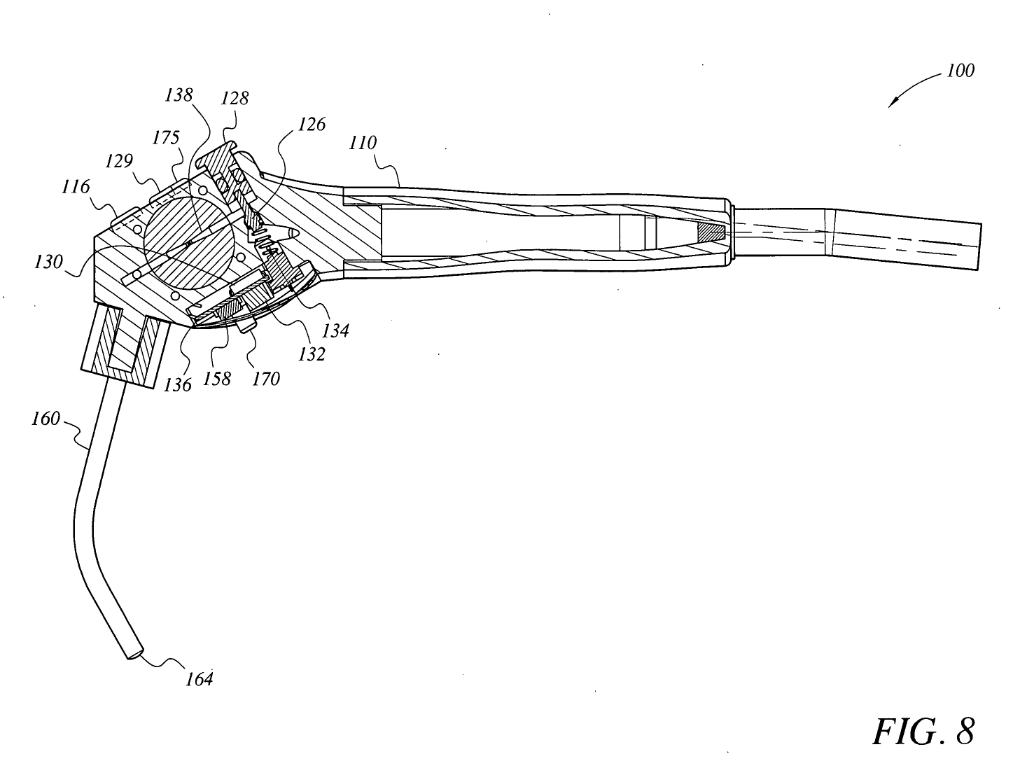

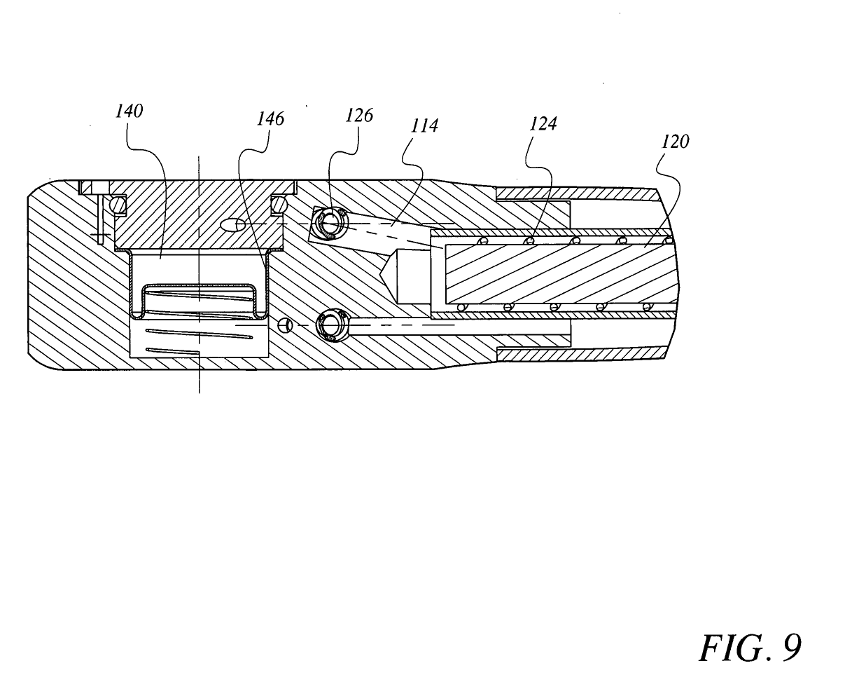

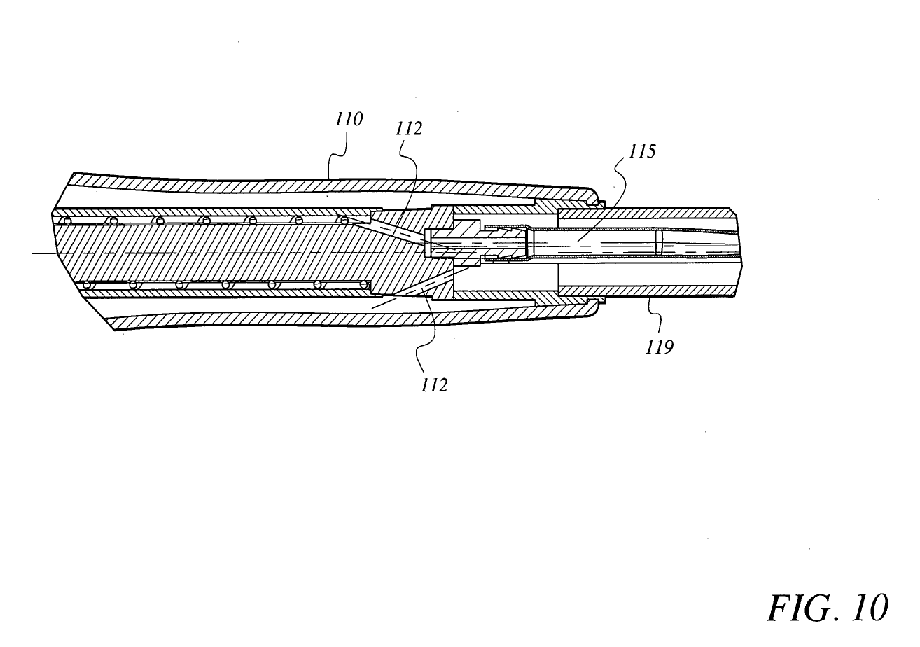

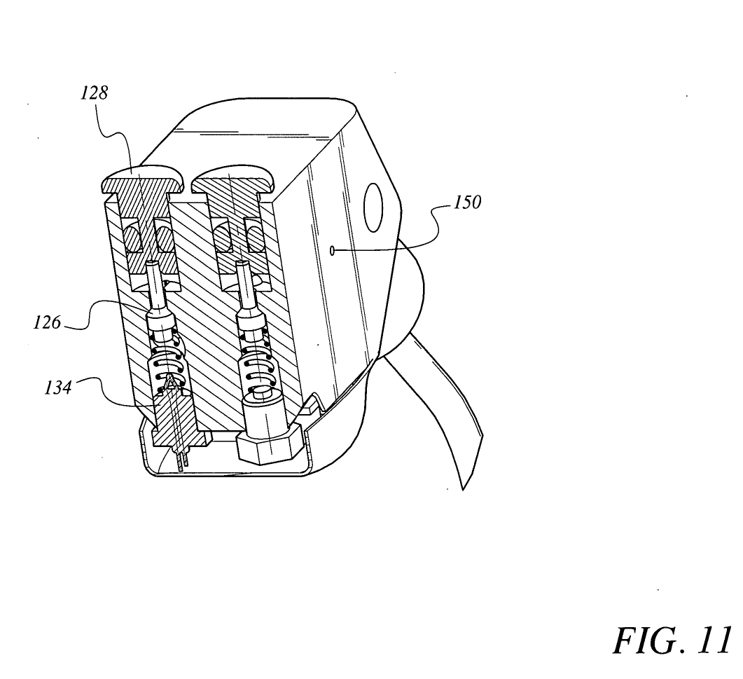

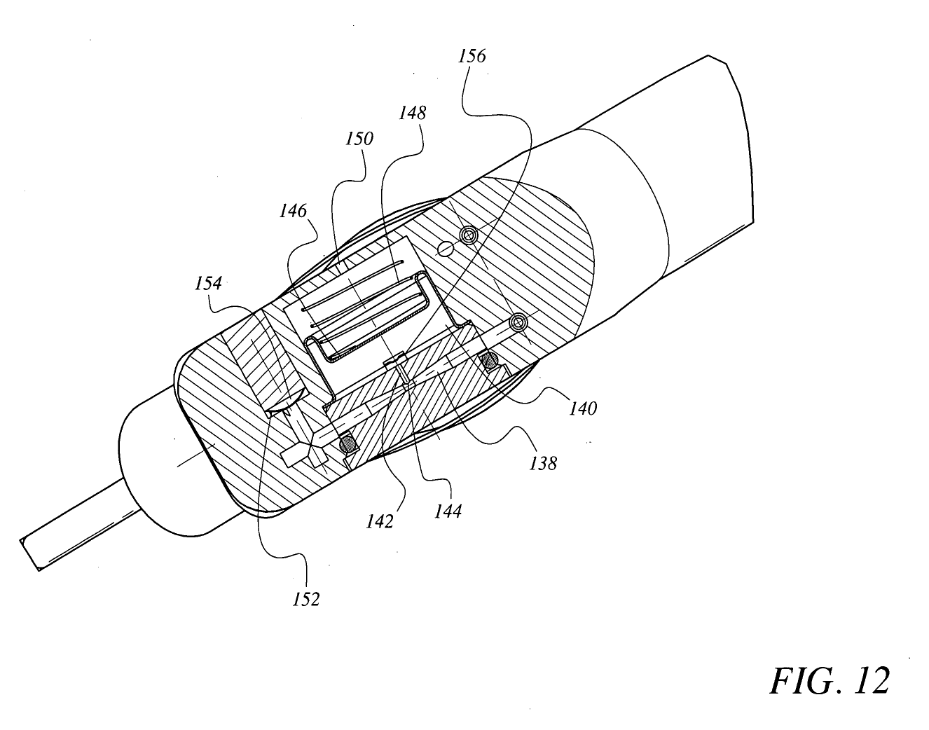

Referring to the drawings, FIGS. 1-12 show a handpiece apparatus 100 for dispensing media including heated water, air, or other fluid or gaseous media, and that can include one or more lights for illumination and/or for curing of composite materials. The handpiece apparatus 100 may be configured in a variety ways. Alternatively, any known or existing handpiece apparatuses may be modified or retrofitted in accordance with the invention. The handpiece apparatus 100 is configured to use in dental procedures or in other applications where temperature controlled temperature dispensing of heated fluid or gaseous media is desired or necessary. The handpiece apparatus 100 has a housing 110, an inlet port 112, an outlet port 114, one or more flexible tubes 115, a heating device 120, a heating chamber 122, and a flow diverter 124. The handpiece apparatus 100 also has a flow valve 126, a pushbutton 128, and an on/off switch 130.

Contained within the handpiece apparatus 100 are a temperature controller 132, a temperature sensor 134, a printed circuit board 136, a vacuum generator 138, an accumulator chamber 140, an accumulator inlet/outlet tube 142, a low pressure port 144, a membrane 146, a spring 148, a vent tube 150, a pressure relief valve 152, a pressure relief valve spring 154, a flow restrictor 156, a motion sensor 158, and a dispensing nozzle 160. The dispensing nozzle 160 includes one or more passageways 162, a nozzle tip 164, a swivel mechanism 166, a quick release mechanism 168, one or more light sources 170, and one or more light switches 174 and 175. The handpiece apparatus 100 is configured to receive power from an external power source, such as from a utility power line or an independent generating power source.

The heating device 120 may be configured as an in-line electric heater for heating fluid or gaseous media, such as air, water, etc., to a temperature suitable for dental operations or in other applications where temperature controlled temperature dispensing of heated fluid or gaseous media is desired or necessary, and the handpiece apparatus 100 is configured to ensure that no media is dispensed outside of a predetermined temperature range. The housing 110 encloses one or more inner passageways configured to transport media within the housing 110. The inlet port 112 and outlet port 114 extend from either end of the housing 110. The heating device 120 is placed proximate the inlet port 112 within a cylindrical chamber, and is spaced concentrically therefrom, through which media to be heated is circulated.

The heating chamber 122 is fitted with a helical flow diverter 124 which is wrapped around the heating device 120 to direct the flow of media around the heating device 120 in a helical direction. The diameter of the heating chamber 122 is sized so that the flow diverter 124 is in close proximity with both the outer surface of the cylindrical heating device 120 and the inner wall of the cylindrical heating chamber 122. This configuration can optimize the heat transfer from the heating device 120 to the media and therefore facilitate rapid heating of the media.

The media may be stored in a remote reservoir (not shown) and be supplied to the handpiece apparatus 100 under pressure through one or more flexible tubes 115 that extend from the remote reservoir to the inlet port 112 of the handpiece apparatus 100. One or more of the flexible tubes 115 may be surrounded by a flexible sheath 119. Media enters the inlet port 112 and fills the heating chamber 122. The heated media is then transferred from the heating chamber 122 by the activation of the manually actuated flow valve 126 placed in line between the heating chamber 122 and the outlet port 114. The flow valve 126 is activated through depression of the mechanical pushbutton 128. Once depressed, the pushbutton 128 activates the manual electrical on/off switch 130 which activates the temperature controller 132 for as long as the flow valve 126 is in an open position.

The temperature controller 132 uses the feedback from the temperature sensor 134 and the motion sensor 158 to thermostatically control the heating device 120 to assure proper temperature of the media within a predetermined temperature range, and to prevent it from becoming overheated to a temperature that would be uncomfortable or unsafe. The temperature controller 132 is preferably configured as a fast acting temperature controller that rapidly responds in a transient manner to a temperature difference between the temperature of the media and predetermined temperature threshold values of the temperature controller 132. For convenience of assembly, the control components may be mounted on the printed circuit board 136.

Activation of the flow valve 126 permits the media to flow from the heating chamber 122 into a tube containing the vacuum generator 138. The vacuum generator 138 is a portion of the tube having a shape that generates low pressure or vacuum, such as a venturi. The accumulator chamber 140 is positioned adjacent the vacuum generator 138. The accumulator inlet/outlet tube 142 is positioned between the low pressure port 144 of the vacuum generator 138 and the accumulator chamber 140. The accumulator inlet/outlet tube 142 permits media to flow from the vacuum generator 138 into the accumulator chamber 140, and alternately, out from the accumulator chamber 140 to the vacuum generator 138. The accumulator chamber 140 is equipped with a membrane 146 that expands when the media enters into the accumulator chamber 140 and contracts when the media exits from the accumulator chamber 140. A compression spring 148 applies pressure on the membrane 146. A vent tube 150 releases pressure behind the membrane 146 so that it does not inhibit the expansion and contraction of the membrane 146.

When the flow valve pushbutton 128 is activated, heated media passes from the heating chamber 122 to the outlet port 114, however during periods of inactivity, the media in the syringe sits in the passageways and becomes cooler. In order to deliver media to the work area at a consistently warm temperature, the initial squirt of media is diverted into the accumulator chamber 140, and thus the cooler media is drawn out of the flow. After the accumulator chamber 140 is full, the subsequent flow of heated media flows toward the outlet port 114.

A non-linear pressure relief valve 152 is placed in line between the accumulator inlet/outlet tube 142 and the outlet port 114. The pressure relief valve spring 154 is preferably sized to open at a higher pressure than the accumulator spring 148, and at a pressure below the inlet pressure of the inlet port 112. The pressure relief valve 152 prevents the media from flowing to the outlet port 114 until the accumulator chamber 140 is completely filled. After the accumulator chamber 140 is filled, the pressure of the flow of media rises to overcome the pressure relief valve 152, and the valve 152 opens completely to permit unrestricted flow of media to the outlet port 114.

The flow of media through the vacuum generator 138 creates a low pressure zone next to the low pressure port 144 and the accumulator inlet/outlet tube 142 which causes the media in the accumulator chamber 140 to gradually empty back into the flow of media as it passes to the outlet port 114. The accumulator chamber 140 empties its contents at a slow rate that does not significantly reduce the overall temperature of the media. When the flow valve 126 is deactivated, the flow stops and the pressure relief valve 152 automatically resets to a closed position. The pressure relief valve 152 assumes an open position when a predetermined opening pressure is exceeded in the chamber 140. Once in the open position, the pressure relief valve 152 remains open until the pressure in the chamber 140 falls below a predetermined closing pressure. The predetermined opening pressure is substantially greater than the predetermined closing pressure.

The non-linear pressure relief valve 152 may be made of a ball and spring or other configuration, or alternately it may be made from a thin metal dome that is captured by its edges inside a cylindrical recess by an enclosing floor or cover. The convex face of the dome is compressed against an inlet opening centered directly on its apex and along its central axis. When the valve 152 is in the closed position, the convex side of the dome maintains a sealing contact with the circumferential edge of the input port. An output tube is located on the bottom or side of the cylindrical recess, connecting to the outlet port 114 and the dispensing nozzle 160. After the accumulator chamber 140 is filled, the pressure of the flow of media rises and is applied on

When the pressure exceeds the spring force of the dome, it causes it to deflect downward thus allowing the media to flow to the outlet port 114. The nature of the metal dome design is such that the force is inversely proportional to the amount of deflection, therefore allowing unimpeded flow of media to the outlet port 114 when the valve 152 is in the open position. However, as the flow subsides, and the pressure in the inlet port 112 is reduced significantly, the dome snaps back to its original shape and resets the valve 152 to the closed position. The floor or cover of the cylindrical valve chamber can be grooved to allow media to flow under the concave side of the dome, and thereby equalize the pressure with the circumferential area on the convex side of the dome and outlet port 114. The edges of the dome can be shaped to permit media to flow under the dome.

The accumulator flow restrictor 156 is mounted adjacent to the accumulator inlet/outlet tube 142. The flow restrictor 156 permits unimpeded flow of media into the accumulator chamber 140, but reduces the flow of media out of the accumulator chamber 140 back into the stream of media if the media is below a predetermined temperature. This prevents the cooler contents of the accumulator chamber 140 from reentering the stream before the stream is heated sufficiently to prevent reducing the temperature of the combined stream of media to a temperature lower than the specified range. The flow restrictor 156 can be formed as a thin bi-metal plate mounted adjacent to the accumulator inlet/outlet tube 142. The bi-metal plate can deflect as the temperature rises to open the accumulator inlet/outlet tube 142 and permit flow from the accumulator chamber 140 back into the media stream.

Within the handpiece apparatus housing 110, the motion sensor 158 is wired in parallel with the electrical pushbutton on/off switch 128, and activates the heating device 120 as the user removes the handpiece apparatus 100 from its holder. Activation of the motion sensor 158 causes the heating device 120 to be energized. This allows the heating device 120 to preheat the contents of the heating chamber 122, thereby reducing the length of time required before heated media can be dispensed at the desired temperature range.

The removable dispensing nozzle 160 extends from the media outlet port 114 to conveniently reach the work area. The nozzle 160 contains one or more tubular passageways for media to flow from the handpiece apparatus 100 to the nozzle tip 164. The nozzle 160 is provided with a swivel mechanism 166 to permit access to variously angled work areas within an oral cavity. The nozzle 160 is removably mounted to the handpiece apparatus 100 with a quick release mechanism for fast and easy replacement.

The nozzle 160 can be made from transparent or translucent glass, acrylic, quartz, or plastic and is configured as a light pipe. One or more light sources 170 can be placed inside the housing 110 adjacent to both the media outlet port 114 and the inlet end of the nozzle 160. Light is internally reflected within the walls of the nozzle 160 and transmitted from the light source(s) 170 to the nozzle tip 164. The tip 164 can be contoured convexly, concavely, angled, or flat to act as a lens to focus the illumination in the desired angle, direction, and focal distance.

The light source(s) 170 are preferably positioned within the housing 110 of the handpiece apparatus 100, e.g., within the section of the housing 110 next to the outlet port 114 in a direction to illuminate the inlet of the nozzle 160, and can emit light of various wavelength, duration, and intensity, including light in the visible spectrum to illuminate the work area, or ultraviolet light, pulsating light, or high intensity light to accelerate the curing of composite materials, or infrared light to heat and dry the work area. The light source(s) 170 can be configured to operate at a lower power level for illumination and at a higher power level or in a pulsating mode for curing composite materials. Activation of the flow valve pushbutton 128 that activates the on/off switch 130 can simultaneously activate the light source(s) 170. A separate pushbutton switch 175 can activate the light source(s) 170.

The handpiece apparatus 100 may be provided with an adjustable temperature dial 116 to enable a user to easily adjust the temperature of media being discharged from the handpiece apparatus 100 within a safe and comfortable range. The handpiece apparatus 100 may also be provided with curing control buttons 129 to adjust intensity and duration of the light source(s) 170. The handpiece apparatus 100 may also be provided with visible indicators 117 and 118, such as light emitting diodes (LEDs) or the like, to indicate the operational status of the handpiece apparatus 100.

For example, the handpiece apparatus 100 may be equipped with a green LED 117 and a yellow LED 118 in addition to the light source(s) 170. Such LEDs 117 and 118 may be configured so the green LED 117 blinks when the handpiece apparatus 100 is in a standby operational condition. The green LED 117 may then become solid when the handpiece apparatus 100 is ready for operational use. The yellow LED 118 blinks when the media is within the predetermined temperature range, and may become solid when dispensed media has a temperature level over a predetermined temperature threshold, such as two degrees or the like. If the yellow LED 118 remains solid in excess of a predetermined time, such as two seconds or the like, the green LED 117, the yellow LED 118, and the light source(s) 170 may all simultaneously blink, and the handpiece apparatus 100 can become deactivated or inoperable until appropriate maintenance is performed on the handpiece apparatus 100.

As previously described, the handpiece apparatus 100 may be configured in a variety ways and/or corresponding dispensing methods may be utilized. Alternatively, any known or existing handpiece apparatuses may be modified or retrofitted in accordance with the invention. The handpiece apparatus and/or corresponding dispensing methods can be used in dental procedures or in other applications where temperature controlled temperature dispersing of heated fluid or gaseous media is desired or necessary. For example, a first example of a handpiece apparatus and/or dispensing method according to the invention may be configured with a housing, heating means for heating media to a temperature within a predetermined temperature range, and lighting means for effecting at least one of the group consisting of illuminating a work area, and curing at least one composite material, the lighting means having at least one light source and being positioned within the housing of the handpiece apparatus, wherein the handpiece apparatus is configured to dispense media within the predetermined temperature range, and to effect at least one of the group consisting of illuminating the work area, and curing the at least one composite material.

This handpiece apparatus may have temperature controlling means for regulating the heating means for heating media to a temperature within the predetermined temperature range. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

This handpiece apparatus may include temperature sensing means for sensing temperature of media, and motion sensing means for sensing motion of the handpiece apparatus and activating the heating means upon sensing motion of the handpiece apparatus. The handpiece apparatus may have removable nozzle means for dispensing media to a work area, and swiveling means for orienting the removable nozzle means at a variety of angles in a work area.

A second example of a handpiece apparatus and/or method for dispensing media includes heating means for heating media to a temperature within a predetermined temperature range, chambering means for accumulating media, and diverting means for diverting media to the chambering means when pressure within the chambering means is below a predetermined opening pressure threshold, wherein the handpiece apparatus is configured to dispense media within the predetermined temperature range.

This handpiece apparatus may be configured with flow restricting means for discharging media from the chambering means into media heated by the heating means, valving means for activating flow of media, and switching means for activating the heating means. The diverting means may include vacuum generating means for causing media in the chambering means to empty back into media heated by the heating means, and pressure relief valving means for assuming an open position when the predetermined opening pressure is exceeded in the chambering means, and remaining in the open position until the pressure in the chambering means falls below a predetermined closing pressure.

This handpiece apparatus may have flow restricting means for restricting flow of media from the chambering means when the media has a temperature value below a predetermined temperature value. This handpiece apparatus may have lighting means for effecting at least one of the group consisting of illuminating a work area, and curing at least one composite material. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

A third example of a handpiece apparatus and/or method for dispensing media includes heating means for heating media to a temperature within a predetermined temperature range, and motion sensing means for sensing motion of the handpiece apparatus and activating the heating means upon sensing motion of the handpiece apparatus, wherein the handpiece apparatus is configured to dispense media within the predetermined temperature range. The handpiece apparatus may have valving means for activating flow of media, and switching means for activating the heating means. The handpiece apparatus may have lighting means for effecting at least one of the group consisting of illuminating a work area, and curing at least one composite material. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

A fourth example of a handpiece apparatus and/or method for dispensing media includes a housing, light piping means for passing light therethrough, lighting means for effecting at least one of the group consisting of emitting light through the light piping means and onto a work area, and curing at least one composite material, the lighting means having at least one light source and being positioned within the housing, and dispensing means for dispensing media from the handpiece apparatus, wherein the handpiece apparatus is configured to dispense media in the work area being illuminated by the light means. The lighting means includes at least one means selected from the group consisting of illuminating light means for emitting radiation in the visible spectrum to illuminate the work area; curing light means for emitting radiation to cure at least one composite material, the curing light means being selected from the group consisting of ultraviolet light, pulsating light, and high intensity light; and heating light means for emitting infrared radiation to heat and dry the work area.

An example of an apparatus for controlling flow of media that includes at least one inlet port means for receiving media, at least one outlet port means for dispensing media, and a snap action check valving means for assuming an open position when a predetermined opening pressure is exceeded at the at least one inlet port means, and remaining in the open position until pressure at the at least one inlet port means falls below a predetermined closing pressure, wherein the predetermined opening pressure is substantially greater than the predetermined closing pressure. The snap action check valving means includes a flexible convex dome, wherein in the closed position the convex surface of the dome is in contact with the at least one inlet port means and forms a seal between the dome and the at least one inlet port means.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A handpiece apparatus for dispensing media, said handpiece apparatus comprising:
a housing;
heating means for heating media to a temperature within a predetermined temperature range; and
lighting means for effecting at least one of the group consisting of illuminating a work area, and curing at least one composite material, the lighting means having at least one light source and being positioned within the housing of the handpiece apparatus,
wherein said handpiece apparatus is configured to dispense media within the predetermined temperature range, and to effect at least one of the group consisting of illuminating the work area, and curing said at least one composite material.

2. The handpiece apparatus according to claim 1, further comprising:
temperature controlling means for regulating said heating means for heating media to a temperature within the predetermined temperature range.

3. The handpiece apparatus according to claim 1, wherein said lighting means comprises at least one means selected from the group consisting of:
illuminating light means for emitting radiation in the visible spectrum to illuminate the work area;
curing light means for emitting radiation to cure at least one composite material, the curing light means being selected from the group consisting of ultraviolet light, pulsating light, and high intensity light; and
heating light means for emitting infrared radiation to heat and dry the work area.

4. The handpiece apparatus according to claim 1, further comprising:
temperature sensing means for sensing temperature of media; and
motion sensing means for sensing motion of said handpiece apparatus and activating said heating means upon sensing motion of said handpiece apparatus.

5. The handpiece apparatus according to claim 1, further comprising:
removable nozzle means for dispensing media to a work area; and
swiveling means for orienting said removable nozzle means at a variety of angles in a work area.

6. A method for dispensing media, said method comprising:
providing a handpiece apparatus with heating means for heating media to a temperature within a predetermined temperature range, and lighting means for effecting at least one of the group consisting of illuminating a work area, and curing at least one composite material;
heating media to a temperature within a predetermined temperature range with the heating means;
effecting, by the lighting means, at least one of the group consisting of illuminating a work area, and curing at least one composite material;
dispensing media within the predetermined temperature range.

7. A handpiece apparatus for dispensing media, said handpiece apparatus comprising:
heating means for heating media to a temperature within a predetermined temperature range;
chambering means for accumulating media; and
diverting means for diverting media to the chambering means when pressure within the chambering means is below a predetermined opening pressure threshold;
wherein said handpiece apparatus is configured to dispense media within the predetermined temperature range.

8. The handpiece apparatus according to claim 7, further comprising:
flow restricting means for discharging media from said chambering means into media heated by said heating means.

9. The handpiece apparatus according to claim 7, further comprising:
valving means for activating flow of media; and
switching means for activating said heating means.

10. The handpiece apparatus according to claim 7, wherein said diverting means comprises:
vacuum generating means for causing media in said chambering means to empty back into media heated by said heating means; and
pressure relief valving means for assuming an open position when the predetermined opening pressure is exceeded in the chambering means, and remaining in the open position until the pressure in the chambering means falls below a predetermined closing pressure.

11. The handpiece apparatus according to claim 7, further comprising flow restricting means for restricting flow of media from said chambering means when said media has a temperature value below a predetermined temperature value.

12. The handpiece apparatus according to claim 7, further comprising:
lighting means for effecting at least one of the group consisting of illuminating a work area, and curing at least one composite material.

13. The handpiece apparatus according to claim 12, wherein said lighting means comprises at least one means selected from the group consisting of:
illuminating light means for emitting radiation in the visible spectrum to illuminate the work area;
curing light means for emitting radiation to cure at least one composite material, the curing light means being selected from the group consisting of ultraviolet light, pulsating light, and high intensity light; and
heating light means for emitting infrared radiation to heat and dry the work area.

14. A method for dispensing media, said method comprising:
providing a handpiece apparatus for dispensing media, the handpiece apparatus including heating means for heating media to a temperature within a predetermined temperature range, chambering means for accumulating media, and diverting means for diverting media to the chambering means when pressure within the chambering means is below a predetermined opening pressure threshold;
heating media to a temperature within a predetermined temperature range with the heating means;
accumulating media with the chambering means;
diverting media with the diverting means to the chambering means when pressure within the chambering means is below a predetermined opening pressure threshold;
discharging media with the discharging means from the chambering means into media heated by the heating means; and
dispensing media within the predetermined temperature range from the handpiece apparatus.

15. A handpiece apparatus for dispensing media, said handpiece apparatus comprising:
heating means for heating media to a temperature within a predetermined temperature range; and
motion sensing means for sensing motion of said handpiece apparatus and activating said heating means upon sensing motion of said handpiece apparatus,
wherein said handpiece apparatus is configured to dispense media within the predetermined temperature range.

16. The handpiece apparatus according to claim 15, further comprising:
valving means for activating flow of media; and
switching means for activating said heating means.

17. The handpiece apparatus according to claim 15, further comprising:
lighting means for effecting at least one of the group consisting of illuminating a work area, and curing at least one composite material.

18. The handpiece apparatus according to claim 17, wherein said lighting means comprises at least one means selected from the group consisting of:
illuminating light means for emitting radiation in the visible spectrum to illuminate the work area;
curing light means for emitting radiation to cure at least one composite material, the curing light means being selected from the group consisting of ultraviolet light, pulsating light, and high intensity light; and
heating light means for emitting infrared radiation to heat and dry the work area.

19. A method for dispensing media, said method comprising:
providing a handpiece apparatus with heating means for heating media to a temperature within a predetermined temperature range, and motion sensing means for sensing motion of the handpiece apparatus and activating the heating means upon sensing motion of the handpiece apparatus;
heating media to a temperature within a predetermined temperature range with the heating means; and
sensing motion of said handpiece apparatus with the motion sensing means and activating the heating means upon sensing motion of the handpiece apparatus,
dispensing media within the predetermined temperature range from the handpiece apparatus.

20. A handpiece apparatus for dispensing media, said handpiece apparatus comprising:
a housing;
light piping means for passing light therethrough;
lighting means for effecting at least one of the group consisting of emitting light through said light piping means and onto a work area, and curing at least one composite material, the lighting means having at least one light source and being positioned within the housing; and
dispensing means for dispensing media from said handpiece apparatus,
wherein said handpiece apparatus is configured to dispense media in the work area being illuminated by said light means.

21. The handpiece apparatus according to claim 20, wherein said lighting means comprises at least one means selected from the group consisting of:
illuminating light means for emitting radiation in the visible spectrum to illuminate the work area;
curing light means for emitting radiation to cure at least one composite material, the curing light means being selected from the group consisting of ultraviolet light, pulsating light, and high intensity light; and
heating light means for emitting infrared radiation to heat and dry the work area.

22. An apparatus for controlling flow of media, said apparatus comprising:
at least one inlet port means for receiving media;
at least one outlet port means for dispensing media; and
a snap action check valving means for assuming an open position when a predetermined opening pressure is exceeded at the at least one inlet port means, and remaining in the open position until pressure at the at least one inlet port means falls below a predetermined closing pressure,
wherein the predetermined opening pressure is substantially greater than the predetermined closing pressure.

23. The apparatus according to claim 22, wherein said snap action check valving means comprises:
a flexible convex dome, wherein in the closed position the convex surface of said dome is in contact with said at least one inlet port means and forms a seal between the dome and said at least one inlet port means.
